(19) United States
(12) Patent Application Publication
(10) Pub. No.: US 2021/0387837 A1
(43) Pub. Date: Dec. 16, 2021

(54) BLOCK AND TACKLE FOR ANTI-TWISTING AND EASY OPEN GLOVE FRIENDLY SNAP

(71) Applicant: Eagle Line Tools, Inc., Ross, OH (US)

(72) Inventor: Robert Brennan, Harrison, OH (US)

(21) Appl. No.: 17/345,905

(22) Filed: Jun. 11, 2021

Related U.S. Application Data
(60) Provisional application No. 63/038,491, filed on Jun. 12, 2020.

(51) Int. Cl. B66D 3/04; B66D 3/06

(52) U.S. Cl. CPC B66D 3/046; H02G 1/06; B66D 3/06

(57) ABSTRACT

The pulley for a block and tackle system includes a shell, a sheave, and a pin. The shell includes a shell pinhole extending through the center of the shell. The sheave includes a sheave pinhole extending the center of the sheave. The pin extends through the shell pinhole and the sheave pinhole, the pin operable to fix a position of the sheave in two directions with respect to the shell. A swivel anchor point is connected to the shell; a hook is connected to the shell and opposite of the swivel anchor. A clasp is fixed to the opening of the hook, in which the hook is operable to connect the pulley to an object, and the clasp comprises wings extending outwardly from the latch.

### TECHNICAL FIELD

Embodiments of the present disclosure generally relate to a block and tackle system for use in high voltage wire and cables, and more particularly to the dual winged clasp that allows for greater functionality and dexterity when wearing high voltage protective gear.

### BACKGROUND

Blocks and tackles are a combination of rope or cable and pulleys that may greatly reduce the amount of force necessary to move or lift an object. A pulley is a collection of one or more wheels over which a rope may be looped to make it easier to lift an object. Pulleys are commonly referred to as simple machines, as they do not have an engine or any gears. At the most fundamental level, pulleys help multiply forces. However, on its own, one pulley can only change the direction of a force. That is, a pulley with one end a rope connected to a load must have an amount of force equal to the weight of the load applied to the opposite end of the rope to maintain the load in equilibrium. With a force less than the weight of the load, the load will move in the direction of gravity, whereas a force greater than the weight of the load will move the load in the opposite direction of the force. While one pulley may be limited in use, a system of pulleys working together may, in addition to changing the direction of a force, multiple the force.

As previously discussed, a plurality of pulleys may be combined, with a rope or cable, to work together as a block and tackle. A block and tackle may comprise an anchor pulley and a moving pulley. Embodiments using two pulleys may commonly be referred to as a “gun tackle.” In a gun tackle, the anchor pulley may be attached to a stationary object, while the moving pulley may be attached to the load. The use of two pulleys multiples the forces in the system and results in a 2:1 mechanical advantage, such that only half the force is necessary to suspend the load, as half the force is being distributed to the anchoring pulley. The same concept may be further applied to block and tackle systems comprising more than one pulley at the anchor pulley, the moving pulley or both. A block may comprise multiple pulleys within one block housing.

For example in a double tackle, as shown in FIG. 1, each of the anchoring pulley and the moving pulley may comprise two pulleys such that the rope passes through each pulley twice, through two separate sheaves and has a 4:1 compacity.

In various environments, users of a block and tackle may be required to wear certain personal protective equipment, or PPE. For example, electrical lineman, those responsible for constructing, maintaining, and repairing power lines and the equipment associated there with, may be required to wear certain PPE. These electrical lineman, when exposed to high voltage equipment, may commonly wear two pairs of gloves, such as a pair of rubber insulated gloves and a pair of leather protector gloves over the pair of rubber insulated gloves.

### SUMMARY

When a user is equipped with PPE, operating a block and tackle may be difficult. This is especially true for electrical lineman, as these individuals lose much of their dexterity when wearing a pair of leather protector gloves over a pair rubber insulated gloves. More specifically, some blocks and tackles may have a hook. In some applications, the hook may have a clasp. The clasp essentially acts as a failsafe, such that a complete closure is formed once the hook is placed on an anchoring point. Without a clasp, the hook does not form a complete closure, and the hook could potentially be inadvertently removed from the anchoring point.

There is an ongoing need to enhance an electrical lineman's mobility and dexterity when removing slack for high voltage electrical cables using a block and tackle while wearing lineman's gloves.

Embodiments of this disclosure includes a block and tackle pulley system. The pulley includes a shell and a hook. The shell includes a shell pinhole, a sheave, and a pin. The shell pinhole extends through the center of the shell. The sheave includes a sheave pinhole, which extends through the center of the sheave. The pin extends through the shell pinhole and the sheave. The pin is configured to fix a position of the sheave in two directions with respect to the shell.

The hook of the pulley is connected to the shell, and a clasp is fixed to the opening of the hook. In embodiments, the hook is configured to connect the pulley to an object. The clasp comprises two wings extending outwardly from the clasp.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 shows an elevation view of the improved block, hook and clasp, in which the dual wings of the clasps are fixed to the opening of the hook. The hook is connect to the shell of the shell. A leadline or rope may be looped though the sheave.

FIG. 2 is a side view of the improved block, hook and clasp.

FIG. 3 is a side view of the improved block, hook and clasp, in which the block further includes a tethering hook.

FIG. 4 is a side view of the improved block and tackle in mock-up use.

The embodiments set forth in the drawings are illustrative in nature and not intended to be limiting to the claims. Moreover, individual features of the drawings will be more fully apparent and understood in view of the detailed description

### DETAILED DESCRIPTION

Specific embodiments of the present disclosure will now be described. The different embodied forms should not be construed as limited to the embodiments set forth herein. Rather, these embodiments are provided so that this disclosure will be thorough and complete, and will fully convey the scope of the present disclosure to those skilled in the art.

Unless otherwise defined, all technical and scientific terms used herein have the same meaning as commonly understood by one of ordinary skill in the art. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

Unless otherwise indicated, all numbers expressing distance, size, or other dimension that are modified by the term “about” as used in the specification and claims are to be understood to vary to the smallest significant figure. Additionally, the disclosure of any ranges in the specification and claims are to be understood as including the range itself and also anything subsumed within the range, as well as endpoints. Unless otherwise indicated, the numerical properties set forth in the specification and claims are approximations that may vary depending on the desired properties sought to be obtained in embodiments of the present disclosure. Notwithstanding that numerical ranges and parameters setting forth the broad scope of the disclosure are approximations, the numerical values set forth in the specific examples are reported as precisely as possible. Any numerical values, however, inherently contain certain errors necessarily resulting from error found in their respective measurements.

As previously stated, some users may experience difficulty with operating the clasp of the pulley or block, when the pulley or block includes a clasp. Again, this is especially true for electrical lineman when they have their leather protector gloves and their rubber insulated gloves on. Accordingly, there is an ongoing need for blocks and tackles with increased dexterity with respect to the clasp.

Embodiments of the present application meet this need by attaching dual wings to the clasp of the hook of the pulley. Conventional clasps may not extend wider than the hook itself. Therefore, users have difficulty retracting the safety lock the pulley may be removed form the anchoring point. According to embodiments herein, the clasp may have a wing that extends outwardly from the clasp, and beyond the width of the hook. These wings may provide an additional contact point for the user to grasp and retract the safety lock such that the hook can be removed from the anchoring point. The wings of the present embodiments may increase the dexterity when the users own dexterity is inhibited, such as by PPE. Phrased differently, the wings of the present embodiment may be glove-friendly.

In one or more embodiments of this disclosure, the pulley includes a shell and a hook. The shell includes a shell pinhole, a sheave, and a pin. The shell pinhole extends through the center of the shell. The sheave includes a sheave pinhole, which extends through the center of the sheave. The pin extends through the shell pinhole and the sheave. The pin is configured to fix a position of the sheave in two directions with respect to the shell. The hook of the pulley is connected to the shell, and a clasp is fixed to the opening of the hook. In embodiments, the hook is configured to connect the pulley to an object. The clasp comprises two wings extending outwardly from the clasp.

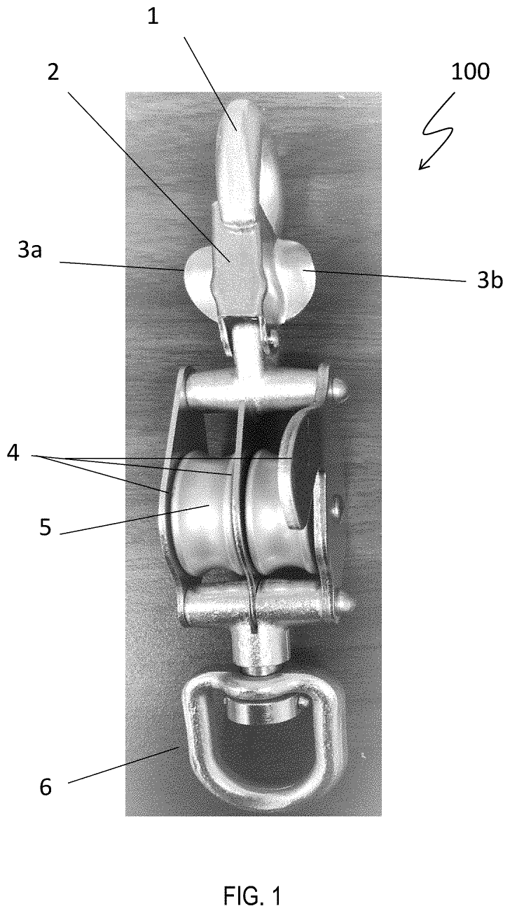

In FIG. 1, the pulley 100 includes a shell 7 and a hook 1. The shell 7 includes at least two sheaves 5 and at least three faces 4. The hook 1 includes a clasp 2, and the clasp include two wings 3a and 3b. The clasp with the two wings may also be called the dual winged clasp. The dual winged clasp is configured to allow greater dexterity for a lineman in bulky rubber lined glove than a single winged clasp or a conventional clasp. In some embodiments, the pulley 100 may include a swivel anchor point 6 to prevent the rope from twisting, as shown in FIG. 1.

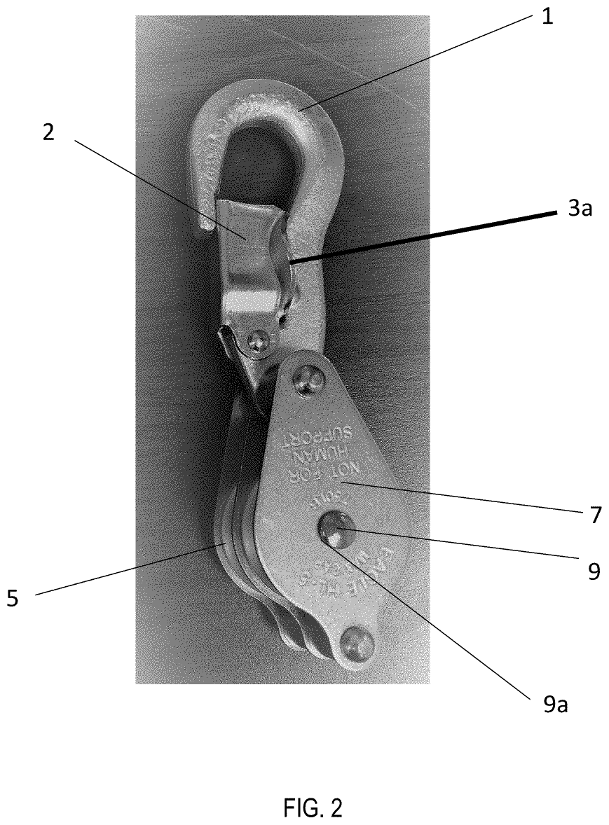

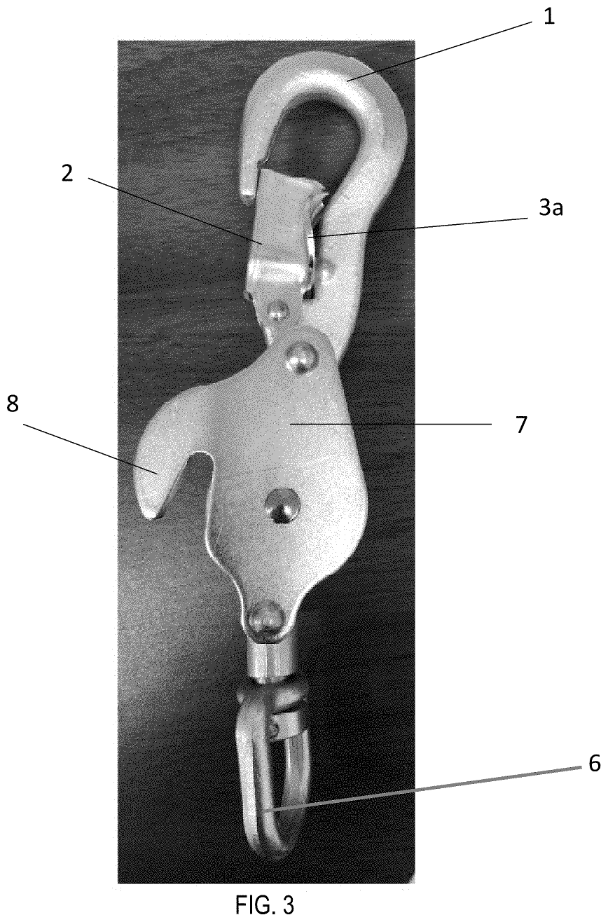

In FIGS. 2 and 3, the shell 7 includes a shell pinhole 9a, a sheave 5, and a pin 9. The shell pinhole 9a extends through the center of the shell. The sheave 5 includes a sheave pinhole, which extends through the center of the sheave. The pin 9 extends through the shell pinhole 9a and the sheave 5. The pin 9 is configured to fix a position of the sheave in two directions with respect to the shell. As shown with particularity in FIG. 3, the shell 7 further includes a shell hook 8.

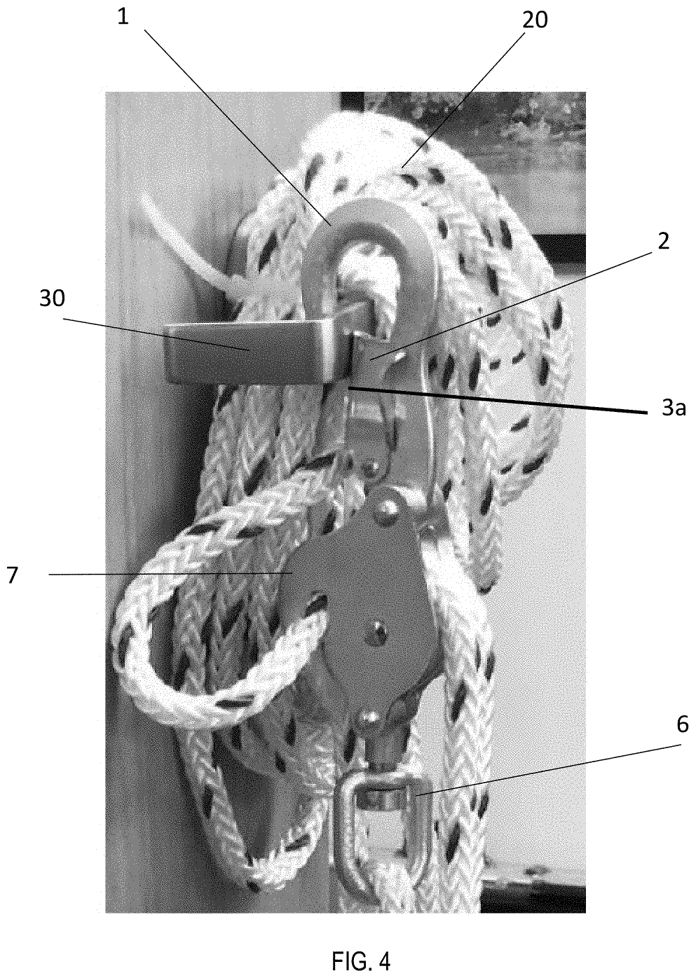

In FIG. 4, the hook 1 of the pulley 100 is connected to the shell 7, and a clasp 2 is fixed to the opening of the hook 1. In embodiments, the hook 1 is configured to connect the pulley to an object 30. Rope 20 is threaded through the pulley 100, and the excess rope 20 is wrapped under the shell hook 7.

While embodiments have been described herein with reference to a fixed pulley or block, applicability to various other types of pulleys and blocks is envisioned, such as, but not limited to snatch blocks, tear drop pulleys, tailboard blocks, blocks with hooks, or blocks with shackles. Additionally, clasps with wings, as described herein, may be applicable to additional applications, not just limited to pulleys, blocks, or blocks and tackles.

What is claimed is:

1. A pulley for a block and tackle system, the pulley comprising:
a shell, the shell comprising a shell pinhole extending through the center of the shell;
a sheave, the sheave comprising a sheave pinhole extending the center of the sheave;
a pin extending through the shell pinhole and the sheave pinhole, the pin operable to fix a position of the sheave in two directions with respect to the shell;
a swivel anchor point connected to the shell;
a hook connected to the shell and opposite of the swivel anchor;
a clasp fixed to the opening of the hook, wherein:
the hook is operable to connect the pulley to an object, and the clasp comprises wings extending outwardly from the latch.

2-5. (canceled)

6. A block and tackle comprising a clasp fixed to the opening of the hook, wherein: the hook is operable to connect a pulley to an object, and the clasp comprises wings extending outwardly from the latch.

7. A process of using the pulley for a block and tackle system of claim 1, the process comprising:
attaching the pulley to electrical wires while wearing gloves using the wings of the clasp.
